(19) United States
(12) Patent Application Publication
(10) Pub. No.: US 2004/0257804 A1
(43) Pub. Date: Dec. 23, 2004

(54) Miniaturized computer keyboard lighting device and associated methods

(76) Inventor: Michael Lee, Orlando, FL (US)

Correspondence Address: ALLEN, DYER, DOPPELT, MILBRATH & GILCHRIST, PA, P.O. BOX 3791, ORLANDO, FL, 32802-3791, US

(21) Appl. No.: 10/857,720

(22) Filed: May 29, 2004

Related U.S. Application Data
(60) Provisional application No. 60/479,476, filed on Jun. 19, 2003.

(51) Int. Cl. H01R 33/00; F21V 33/00

(52) U.S. Cl. 362/226; 362/85

(57) ABSTRACT

An illumination device for portable computers includes a plug adapted for insertion into a socket of a portable computer and a monolithic base that is connected to the plug. An arm of the base has a lower portion extending upwardly from a proximal end of the bottom portion and an upper portion curving inwardly toward the plug in a distal direction. A passageway extends from the distal end to the arm's upper portion. A bulb socket adjacent the arm's upper portion is adapted to support and provide current to an LED. The bulb socket is positioned to permit at least some of the LED light to be emitted in a generally downward direction, so that, in use, light shines on the computer keyboard. Circuitry extends through the passageway and is connected for providing current from the plug's proximal end to the bulb socket.

### CROSS-REFERENCE TO RELATED APPLICATION

This application claims priority to provisional application Ser. No. 60/479,476, filed Jun. 19, 2003, entitled “USB mini light.”

### FIELD OF INVENTION

The present invention generally relates to and, in particular, to illuminating devices, and, more particularly, for improving visualization of computer keyboards.

### BACKGROUND

The need for illuminating computer keyboards, particularly keyboards of portable computers, has been recognized for some time. Such illumination may be desired while traveling on airplanes or other conveyances, or during meetings where the lights may be dimmed for a presentation, or simply to avoid lighting an entire room.

This need has been addressed by detachable computer lights that are adapted to receive power from the computer itself, for example, from a USB port or other type of socket. However, these lights are cumbersome, having long, flexible necks. Therefore, it would be advantageous to provide a computer light that is more compact.

### SUMMARY OF THE INVENTION

The present invention, a first aspect of which is directed to an illumination device for portable computers, comprises a plug that has a distal end that is adapted for insertion into a socket of a portable computer for receiving power therefrom. This device is intended for use primarily with portable computers that have a socket on the side of the keyboard, although this is not intended as a limitation.

The illumination device also comprises a monolithic base that is connected at a distal end to a proximal end of the plug. The base has a bottom portion that extends substantially parallel with the plug. An arm of the base has a lower portion extending upwardly from a proximal end of the bottom portion and an upper portion curving inwardly toward the plug in a distal direction.

The base further has a passageway therethrough that extends from the distal end to the arm's upper portion. A bulb socket adjacent the arm's upper portion is adapted to support and provide current to an LED. The bulb socket is positioned to permit at least some of the LED light to be emitted in a generally downward direction, so that, in use, light shines on the computer keyboard.

The base additionally comprises circuitry that includes wiring. The wiring extends through the passageway and is connected for providing current from the plug's proximal end to the bulb socket.

In another embodiment of the invention, the plug and the monolithic base are formed together, forming a monolithic plug and base unit.

Another aspect of the invention is directed to a method for illuminating a keyboard of a portable computer. The method comprises the step of inserting a distal end of a plug of an illumination device into a socket of a portable computer for receiving power therefrom. The illumination device is constructed substantially as disclosed above.

A further aspect of the invention is directed to a method for making an illumination device. This method comprises the steps of forming a base as described above, and placing a bulb socket adjacent the arm's upper portion. Circuitry is extended through the passageway from the base's distal end to the bulb socket.

A distal end of the base is connected to a proximal end of a plug that has connecting means therein. The base is connected to extend substantially parallel with the plug. The wiring is connected to the plug's connecting means for providing current from the plug proximal end to the bulb socket.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWING

FIG. 1 is a top-side perspective view of the illumination device of the present invention.

FIG. 2 is a side perspective view of the arm.

FIG. 3 is a circuit diagram for the illumination device.

FIG. 4 is a top-side perspective view of the illumination device connected to a portable computer.

### DETAILED DESCRIPTION OF THE PREFERRED EMBODIMENT

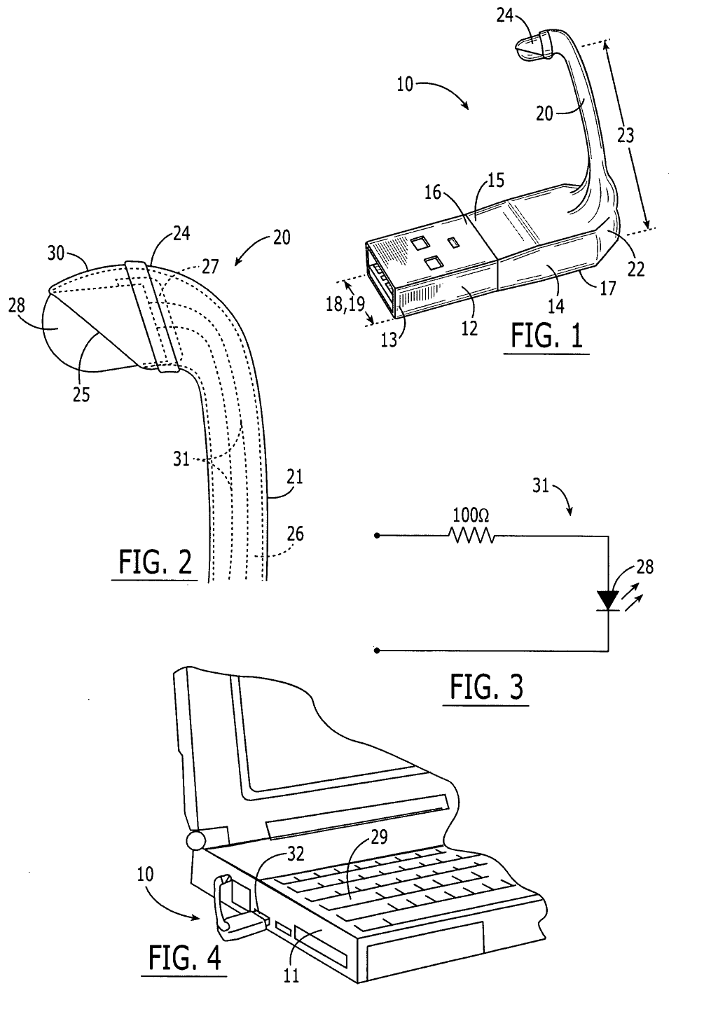

A description of the preferred embodiments of the present invention will now be presented with reference to FIGS. 1-4. A first aspect of the invention is directed to an illumination device 10 (FIG. 1) for portable computers 11 that comprises a plug 12 that has a distal end 13 that is adapted for insertion into a socket of a portable computer for receiving power therefrom. In an exemplary embodiment, the plug 12 is adapted for insertion into a USB port, although this is not intended as a limitation. This device is intended for use primarily with portable computers, such as laptops, that have a socket on the side of the keyboard, although this is not intended as a limitation.

The illumination device 10 also comprises a monolithic base 14 that is connected at a distal end 15 to a proximal end 16 of the plug 12. The base 14 has a bottom portion 17 that extends substantially parallel with the plug 12. In a preferred embodiment, the lateral widths 18,19 of the bottom portion 17 and the plug 12 are substantially equal.

The base 14 also has an arm 20 (FIG. 2) that has a lower portion 21 extending upwardly from a proximal end 22 of the bottom portion 17. Preferably the height 23 of the lower portion 21 is sufficiently large that the arm's upper portion 24, when the plug 12 is engaged with a socket, extends above the computer's keyboard. The upper portion 24 curves inwardly, at an approximately 90° angle, toward the plug 12, in a distal direction. The upper portion 24 has a distal end 25 that forms an angle with the base 14 of approximately 45° in a first embodiment. In a second embodiment, the upper portion's distal end 25 is substantially perpendicular to the base 14. Preferably the arm is flexible and position-retentive, to permit adjustment of the arm.

The base 14 further has a passageway 26 therethrough that extends from the distal end 15 to the arm's upper portion 24. A bulb socket 27 adjacent the arm's upper portion 24 is adapted to support and provide current to an LED 28. The bulb socket 27 in the first embodiment is positioned to permit at least some of the LED light to be emitted in a generally downward direction, so that, in use, light shines on the computer keyboard 29 (see FIG. 4). In the first embodiment, a top section 30 of the arm portion's distal end 31 is configured to at least partially cover an LED 28 positioned in the bulb socket 27, for diminishing glare into the user's eyes. Here the arm portion's distal end 25 substantially coextends with the LED 28.

The base 14 additionally comprises circuitry 31 (FIG. 3) that includes wiring. The wiring extends through the passageway 26 and is connected for providing power from the plug 12 to the bulb socket 27. In a particular embodiment, power is supplied to the bulb socket 27 upon the plug's being inserted into the USB port, although an on/off switch could be contemplated in an alternate embodiment.

In yet another embodiment of the invention, the plug and the monolithic base are formed together, forming a monolithic plug and base unit.

Another aspect of the invention is directed to a method for illuminating a keyboard 29 of a portable computer 11 (FIG. 4). The method comprises the step of inserting a distal end 13 of a plug 12 of an illumination device 10 into a socket 32 of a portable computer 11 for receiving power therefrom. The illumination device 10 is constructed substantially as disclosed above.

A further aspect of the invention is directed to a method for making an illumination device 10. This method comprises the steps of forming a base 14 as described above, and placing a bulb socket 27 adjacent the arm's upper portion 24. Circuitry 31 is extended through the passageway 26 from the base's distal end 15 to the bulb socket 27.

The base's distal end 15 is connected to a proximal end 16 of a plug 12 that has connecting means therein. The base 14 is connected to extend substantially parallel with the plug 12. The wiring 32 is connected to the plug's connecting means 13 for providing current from the plug's proximal end 16 to the bulb socket 27.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

What is claimed is:

1. An illumination device for portable computers comprising:
a plug having a distal end adapted for insertion into a socket of a portable computer for receiving power therefrom; and
a monolithic base connected at a distal end to a proximal end of the plug having:
a bottom portion extending substantially parallel with the plug;
an arm having a lower portion extending upwardly from a proximal end of the bottom portion and an upper portion curving inwardly toward the plug;
a passageway therethrough extending from the distal end to the arm upper portion;
a bulb socket positioned adjacent the arm upper portion adapted to support and provide current to an LED, the bulb socket positioned to permit at least some of the LED light to be emitted in a generally downward and distal direction; and
circuitry including wiring extending through the passageway and connected for providing current from the plug proximal end to the bulb socket.

2. The illumination device recited in claim 1, wherein the plug is adapted for insertion into a USB port.

3. The illumination device recited in claim 1, wherein the plug and the base bottom portion have a substantially equal lateral width.

4. The illumination device recited in claim 1, wherein the arm lower portion has a height dimensioned to place the bulb socket above a keyboard of the computer when in use.

5. The illumination device recited in claim 1, further comprising an LED inserted into the bulb socket.

6. The illumination device recited in claim 1, wherein the arm upper and lower portions meet at angle of approximately 90°.

7. The illumination device recited in claim 1, wherein the arm upper portion has a distal end configured to at least partially cover an LED inserted into the bulb socket, for diminishing glare into user eyes.

8. The illumination device recited in claim 7, wherein the arm upper portion distal end forms an angle of approximately 45° with the arm upper portion with a plane of the base.

9. The illumination device recited in claim 7, wherein a top section of the arm upper portion distal end is configured for substantial coextension with an LED inserted into the bulb socket.

10. The illumination device recited in claim 1, wherein the arm upper portion has a distal end configured to emit light substantially isotropically.

11. The illumination device recited in claim 1, wherein the arm is flexible and position-retentive for permitting adjustment.

12. The illumination device recited in claim 1, wherein the circuitry is adapted to illuminate the LED when a connection is made between the plug and the socket.

13. A method for illuminating a keyboard of a portable computer comprising the step of inserting a distal end of a plug of an illumination device into a socket of a portable computer for receiving power therefrom, the illumination device comprising a monolithic base connected at a distal end to a proximal end of the plug, the base having:
a bottom portion extending substantially parallel with the plug;
an arm having a lower portion extending upwardly from a proximal end of the bottom portion and an upper portion curving inwardly toward the plug;
a passageway therethrough extending from the distal end to the arm upper portion;
a bulb socket positioned adjacent the arm upper portion adapted to support and provide current to an LED, the bulb socket positioned to permit at least some of the LED light to be emitted in a generally downward and distal direction; and
circuitry including wiring extending through the passageway and connected for providing current from the plug proximal end to the bulb socket.

14. The illuminating method recited in claim 13, wherein inserting step comprises inserting the plug into a USB port.

15. The illuminating method recited in claim 13, further comprising the step of inserting an LED into the bulb socket.

16. The illuminating method recited in claim 13, wherein the inserting step causes current to flow to the bulb socket.

17. The illuminating method recited in claim 13, further comprising the step of adjusting the arm to a desired configuration.

18. A method for making an illumination device for portable computers comprising the steps of:
forming a base having:
a bottom portion;
an arm having a lower portion extending upwardly from a proximal end of the bottom portion and an upper portion curving inwardly in a distal direction; and
a passageway therethrough extending from the distal end to the arm upper portion;
placing a bulb socket adjacent the arm upper portion, the bulb socket adapted to support and provide current to an LED and positioned to permit at least some of the LED light to be emitted in a generally downward direction;
extending circuitry including wiring through the passageway from the base distal end to the bulb socket;
connecting a distal end of the base to a proximal end of a plug having connecting means therein, the base extending substantially parallel with the plug; and
connecting the wiring to the plug connecting means for providing current from the plug proximal end to the bulb socket.

19. The method recited in claim 18, wherein the plug connecting means comprises a USB connection.

20. The method recited in claim 18, wherein the plug and the base bottom portion have a substantially equal lateral width.

21. The method recited in claim 18, wherein the arm lower portion has a height dimensioned to place the bulb socket above a keyboard of the computer when in use.

22. The method recited in claim 18, further comprising the step of inserting an LED into the bulb socket.

23. The method recited in claim 18, wherein the arm upper and lower portions meet at angle of approximately 90°.

24. The method recited in claim 18, wherein the arm upper portion has a distal end configured to at least partially cover an LED inserted into the bulb socket, for diminishing glare into user eyes.

25. The method recited in claim 24, wherein the arm upper portion distal end forms an angle of approximately 45° with the arm upper portion with a plane of the base.

26. The method recited in claim 24, wherein the arm upper portion distal end is configured for substantial coextension with an LED inserted into the bulb socket.

27. The method recited in claim 18, wherein the arm upper portion has a distal end configured to emit light substantially isotropically.

28. The method recited in claim 18, wherein the arm is flexible and position-retentive for permitting adjustment.

29. The method recited in claim 18, wherein the circuitry is adapted to illuminate the LED when a connection is made between the plug connecting means and a plug-receiving socket.

30. An illumination device for portable computers comprising a monolithic base having:
a plug portion having a distal end comprising connecting means adapted for mating with a socket of a portable computer for receiving power therefrom;
an arm having a lower portion extending upwardly from a proximal end of the plug portion and an upper portion curving inwardly in a distal direction;
a passageway extending from the plug connecting means to the arm upper portion;
a bulb socket adjacent the arm upper portion adapted to support and provide current to an LED, the bulb socket positioned to permit at least some of the LED light to be emitted in a generally downward and distal direction; and
circuitry including wiring extending through the passageway and connected for providing current from the plug connecting means to the bulb socket.
